(19) United States
(12) Patent Application Publication
(10) Pub. No.: US 2021/0182979 A1
(43) Pub. Date: Jun. 17, 2021

(54) MONITORING DEVICE AND STORAGE MEDIUM ENCODED WITH PROGRAM

(71) Applicant: FANUC CORPORATION, Yamanashi (JP)

(72) Inventors: Kei MUTOBE, Yamanashi (JP); Hiroji NISHI, Yamanashi (JP); Akihiro TERADA, Yamanashi (JP)

(73) Assignee: FANUC CORPORATION, Yamanashi (JP)

(21) Appl. No.: 17/103,067

(22) Filed: Nov. 24, 2020

(30) Foreign Application Priority Data
Dec. 13, 2019 (JP) 2019-225802

(51) Int. Cl. G06Q 50/04; G07C 3/14; G07C 3/00; G06Q 10/06; G05B 19/406

(52) U.S. Cl. CPC G06Q 50/04; G07C 3/146; G05B 2219/32181; G06Q 10/06395; G05B 19/406; G07C 3/005

(57) ABSTRACT

A monitoring device monitors a status of a process in a production line in separate unit tasks. The production line includes a plurality of processes. The unit tasks form the process. The monitoring device includes an operational condition acquisition section, a determination section, and an output section. The operational condition acquisition section acquires, on a per-unit task basis, operational conditions of a device being used in the tasks. The determination section determines whether or not the acquired operational conditions are appropriate based on preset reference values. The output section outputs, on a per-unit task basis, information as to whether or not the process is being appropriately performed, based on results of the determination.

This application is based on and claims the benefit of priority from Japanese Patent Application 2019-225802, filed on 13 Dec. 2019, the content of which is incorporated herein by reference.

### BACKGROUND OF THE INVENTION

### Field of the Invention

The present disclosure relates to a monitoring device and a storage medium encoded with a program.

### Related Art

A known conventional monitoring device monitors a production line that includes a plurality of production devices such as an industrial robot system. The monitoring device manages data at the time of manufacturing product in units of manufacturing processes such as products, production lots or the like. In this context, a delivery date management assisting system has been proposed that performs the management on a per-manufacturing process basis (see, for example, Japanese Unexamined Patent Application, Publication No. 2005-71136).

Patent Document 1: Japanese Unexamined Patent Application, Publication No. 2005-71136

### SUMMARY OF THE INVENTION

In a production line, incidentally, an inspection process is, for example, performed after each product has been assembled to determine whether the product is good or defective. This allows for detection of a problem during the inspection process. However, there is a time lag between when the product goes through a manufacturing process (when the problem occurs) and when the inspection process is performed on the product. It is therefore possible that a product having a quality problem is manufactured during the lag. Furthermore, in the case of the management on a per-manufacturing process basis, it can take a long time to identify a task in which the problem has occurred amongst tasks included in the manufacturing process. It is therefore preferable that a cause of the problem in the production line be identified earlier.

(1) The present disclosure relates to a monitoring device for monitoring a status of a process in a production line in separate unit tasks. The production line includes a plurality of processes. The unit tasks form the process. The monitoring device includes an operational condition acquisition section, a determination section, and an output section. The operational condition acquisition section acquires, on a per-unit task basis, operational conditions of a device being used in the tasks while the device is in operation. The determination section determines whether or not the acquired operational conditions are appropriate based on preset reference values. The output section outputs, on a per-unit task basis, information as to whether or not the process is being appropriately performed, based on results of the determination.

(2) The present disclosure also relates to a storage medium encoded with a program for causing a computer to function as a monitoring device for monitoring a status of a process in a production line in separate unit tasks. The production line includes a plurality of processes. The unit tasks form the process. The program causes the computer to function as an operational condition acquisition section, a determination section, and an output section. The operational condition acquisition section acquires, on a per-unit task basis, operational conditions of a device being used in the tasks. The determination section determines whether or not the acquired operational conditions are appropriate based on preset reference values. The output section outputs, on a per-unit task basis, information as to whether or not the process is being appropriately performed, based on results of the determination.

According to the present disclosure, it is possible to provide a monitoring device that allows for earlier identification of a cause of a problem in a production line and to provide a storage medium encoded with a program.

### BRIEF DESCRIPTION OF THE DRAWINGS

FIG. 1 schematically illustrates a production line to be monitored by a monitoring device according to an embodiment of the present disclosure;

FIG. 2 schematically illustrates relationships between the monitoring device according to the embodiment and other devices;

FIG. 3 is a block diagram illustrating a configuration of the monitoring device according to the embodiment;

FIG. 4 is a table showing operational conditions and preliminary information associated with each other by an association section of the monitoring device according to the embodiment;

FIG. 5 is a screen image illustrating an output from an output section of the monitoring device according to the embodiment;

FIG. 6 is a flowchart showing an operation of the monitoring device according to the embodiment;

FIG. 7 schematically illustrates an additional example of the production line to be monitored by an additional example of the monitoring device;

FIG. 8 schematically illustrates relationships between the additional example the monitoring device and other devices; and

FIG. 9 is a table showing operational conditions and preliminary information associated with each other by the association section of the additional example of the monitoring device.

### DETAILED DESCRIPTION OF THE INVENTION

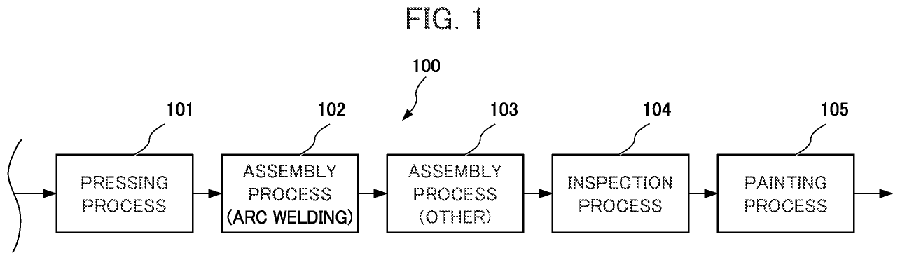

Hereinafter, a monitoring device 1 and a program according to an embodiment of the present disclosure will be described with reference to FIGS. 1 to 6. Referring to FIG. 1, the following first describes relationships between processes and tasks in a production line 100 to be monitored by the monitoring device 1 before describing the monitoring device 1 according to the present embodiment.

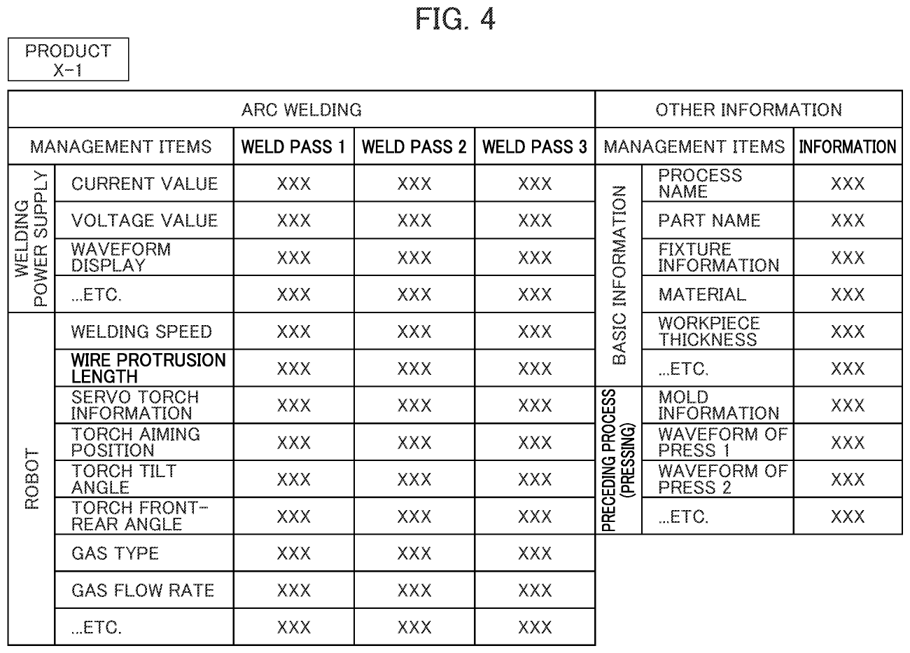

As illustrated in FIG. 1 the production line 100 includes a plurality of processes. The production line 100 includes, for example, a pressing process 101, an assembly process (arc welding) 102, an assembly process (other) 103, an inspection process 104, and a painting process 105. Each of the processes includes a plurality of unit tasks. For example, the assembly process (arc welding) 102 includes, as unit tasks, three joining sites, which are weld passes 1 to 3 (see FIG. 4).

The monitoring device 1 according to the present embodiment monitors the status of a process in separate unit tasks, which form the process. The monitoring device 1 is aimed at identifying a cause of a problem, if any, earlier by monitoring a process in smaller unit tasks as well as directly monitoring operational conditions of devices involved in the process.

Next, the following describes the monitoring device 1 and the program according to the embodiment of the present disclosure. The monitoring device 1 monitors the status of a process in the production line 100, which includes a plurality of processes, in separate unit tasks, which form the process. The present embodiment is described using an example in which the monitoring device 1 monitors the assembly process (arc welding) 102 among the plurality of processes.

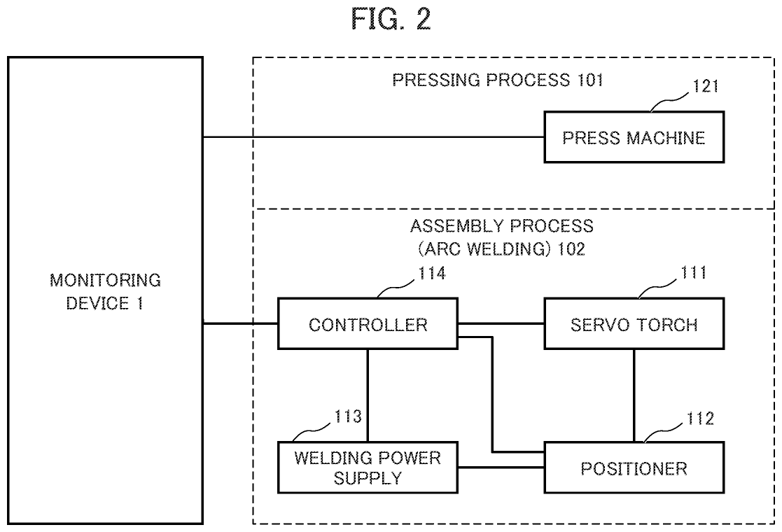

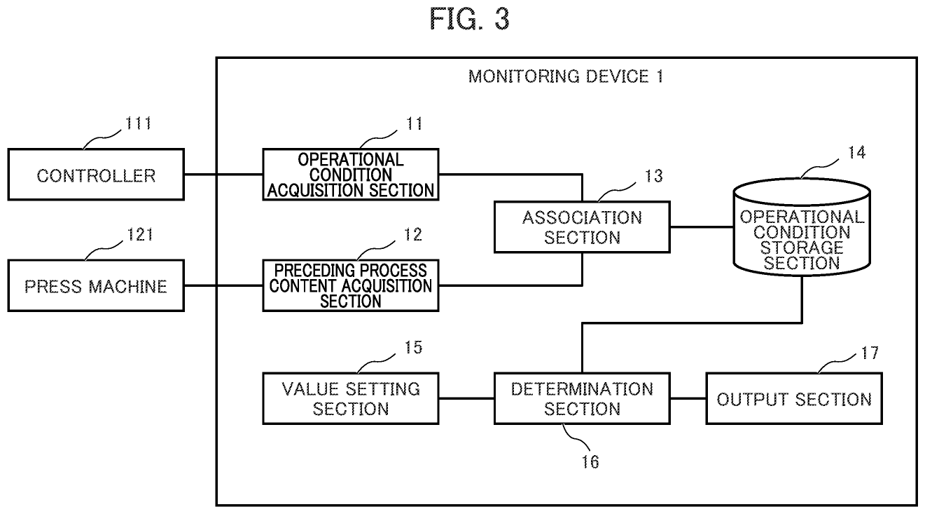

The monitoring device 1 is connected to a device that is used in the assembly process (arc welding) 102. For example, the monitoring device 1 is connected to a controller (robot controller) 114 as illustrated in FIG. 2. The controller (robot controller) 114 controls a servo torch (robot) 111, a positioner 112, and a welding power supply 113. The monitoring device 1 acquires operational conditions of each device from the robot controller 114 on a per-unit task basis. The monitoring device 1 is also connected to a press machine 121 involved in the pressing process 101 preceding the assembly process (arc welding) 102. As illustrated in FIG. 3, the monitoring device 1 includes an operational condition acquisition section 11, a preceding process content acquisition section 12, an association section 13, an operational condition storage section 14, a value setting section 15, a determination section 16, and an output section 17.

The operational condition. acquisition section 11 is, for example, implemented by operating a CPU. The operational condition acquisition section 11 acquires operational conditions of each of devices being used in the tasks on a per-unit task basis. Examples of devices That may be used in the tasks include the servo torch (robot) 111 that performs arc welding, the positioner 112 that adjusts the position or the orientation of a workpiece (not shown), the welding power supply 113 that supplies electric power for arc welding, and the controller 114 that controls the aforementioned devices, as illustrated in FIG. 2. As illustrated in FIG. 4, for example, the operational condition acquisition section 11 acquires, as operational conditions, a current value and the like of the welding power supply 113, and a welding speed and the like of the servo torch (robot) 111 on a per-unit task basis. The operational condition acquisition section 11 also acquires the operational conditions on a per-product basis (product X-1 in the present embodiment).

The preceding process content acquisition section 12 is, for example, implemented by operating the CPU. The preceding process content acquisition section 12 acquires, as the preceding process content, information of processing performed in the process preceding the process for which the operational conditions have been acquired. In the present embodiment, as illustrated in FIG. 2, the preceding process content acquisition section 12 acquires information of processing performed by the press machine 121 in the preceding process (pressing process 101). The preceding process content acquisition section 12 acquires information of processing such as mold information and press waveforms as illustrated in FIG. 4.

The association section 13 is, for example, implemented by operating the CPU. The association section 13 associates the acquired operational conditions with the acquired preceding process content. In the present embodiment, the association section 13 associates the weld passes 1 to 3 (operational conditions) with the mold information and the press waveforms (preceding process content).

The operational condition storage section 14 is, for example, a secondary storage medium such as a hard disk. The operational condition storage section 14 stores the associated operational conditions and preceding process content.

The value setting section 15 is, for example, implemented by operating the CPU. The value setting section 15 sets, as reference values, values for determining an abnormality for the respective acquired operational conditions. For example, the value setting section 15 sets, as each of the reference values, a difference from an average of values of a corresponding operational condition (measured data) acquired from the same process performed a specific number of times in the past, a threshold using a maximum value and a minimum value, or a differential average obtained for a specific period of time.

The determination section 16 is, for example, implemented by operating the CPU. The determination section 16 determines whether or not the acquired operational conditions are appropriate based on the preset reference values. For a current value swing caused by defective welding, for example, the determination section 16 determines that the operational condition is not appropriate by detecting a difference from the reference value that is equal to or greater than a certain value.

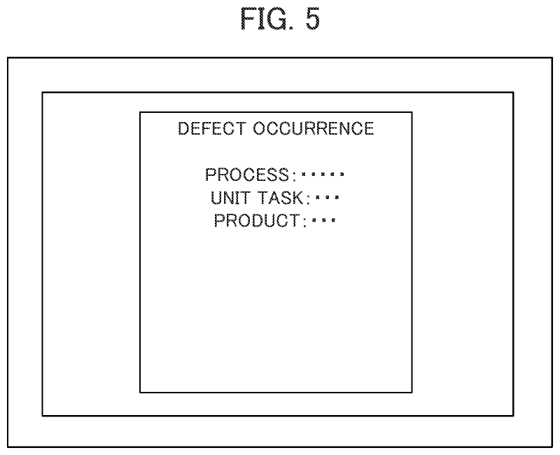

The output section 17 is, for example, implemented by operating the CPU. Based on the results of the above-described determination, the output section 17 outputs, on a per-unit task basis, information as to whether or not the process is being appropriately performed. The output section 17 outputs the operational conditions and the preceding process content associated therewith. For example, the output section 17 causes a mobile terminal (not shown) or the like to display the occurrence of an abnormality (defect) as illustrated in FIG. 5. For example, the output section 17 causes a mobile terminal or the like to display information such as a process, a unit task, and a number identifying a product in which the defect has occurred. The output section 17 further outputs the preceding process content.

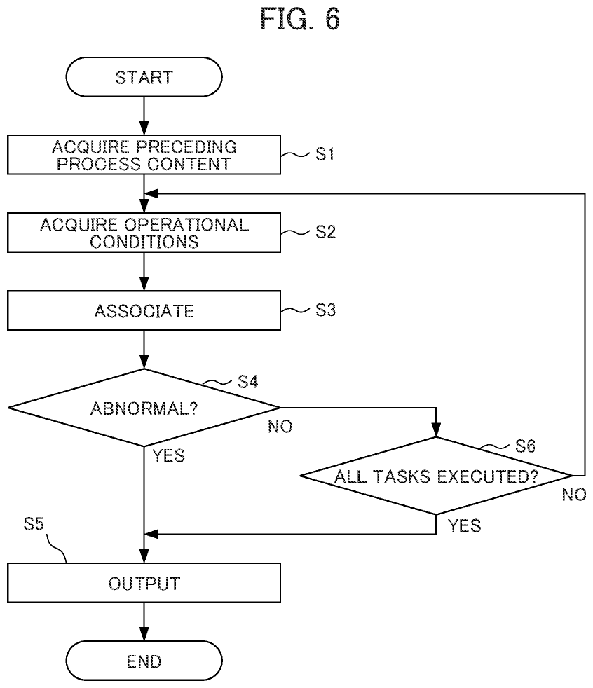

Next, a flow of an operation. of the monitoring device 1 according to the present embodiment will be described with reference to a flowchart in FIG. 6. First, the preceding process content acquisition section 12 acquires a preceding process content (Step S1) Next, the operational condition acquisition section 11 acquires operational conditions (Step S2). Next, the association section 13 associates the operational conditions with the preceding process content (Step S3). The association section 13 stores the associated operational conditions and preceding process content in the operational condition storage section 14.

Next, the determination section 16 determines whether or not the acquired operational conditions are appropriate (Step S4). Specifically, the determination section 16 determines whether or not the operational conditions are appropriate by comparing values of the operational conditions against preset reference values. If any of the operational conditions is abnormal (YES at Step S4), the operation advances to Step S5. If none of the operational conditions are abnormal (NO at Step S4), the operation advances to Step S6.

At Step S5, the output section 17 outputs a signal corresponding to the operational condition determined to be abnormal and indicating the abnormality on a per-unit task basis. The output section 17 also outputs the operational condition determined to be abnormal and the preceding process content. This brings an end to the flow of the operation. At Step 56, whether or not all of the tasks have been executed is determined. If all the tasks have been executed (YES at Step S6), the flow of the operation ends. If the execution of the tasks is to be continued. (if there is a unit task to be executed next; NO at Step S6), the operation returns to Step S2.

Next, the program according to the embodiment of the present disclosure will be described. Each of the constituents of the monitoring device 1 can be implemented by hardware, software, or a combination thereof. Being implemented by software herein means being implemented through a computer reading and executing a program.

The program can be supplied to the computer by being stored on any of various types of non-transitory computer readable media. The non-transitory commuter readable media include various types of tangible storage media. Examples of non-transitory computer readable media include magnetic storage media (such as flexible disks, magnetic tape, and hard disk drives), magneto-optical storage media (such as magneto-optical disks), compact disc read only memory (CD-ROM), compact disc recordable (CD-R), compact disc rewritable (CD-R/W), and semiconductor memory (such as mask ROM, programmable ROM (PROM) , erasable PROM (EPROM), flash ROM, and random access memory (RAM)). Alternatively, the program may be supplied to the computer using any of various types of transitory computer readable media. Examples of transitory computer readable media include electrical signals, optical signals, and electromagnetic waves. Such transitory computer readable media can supply the program to the computer through a wireless communication channel or a wired communication channel such as an electrical wire or optical fiber.

The monitoring device 1 and the program according to the embodiment described above produce the following effects. (1) A monitoring device 1 for monitoring a status of a process in a production line 100 in separate unit tasks, the production line 100 including a plurality of processes, the unit tasks forming the process, the monitoring device 1 including: an operational condition acquisition section 11 configured to acquire, on a per-unit task basis, operational conditions of a device being used in toe tasks; a determination section 16 configured to determine whether or not the acquired operational conditions are appropriate based on preset reference values; and an output section 17 configured to output, on a per-unit task basis, information as to whether or not the process is being appropriately performed, based on results of the determination. A program for causing a computer to function as a monitoring device 1 for monitoring a status of a process in a production line 100 in separate unit tasks, the production line 100 including a plurality of processes, the unit tasks forming the process, the program being configured to cause the computer to function as: an operational condition acquisition section 11 configured to acquire, on a per-unit task basis, operational conditions of a device being used in the tasks; a determination section 16 configured to determine whether or not the acquired operational conditions are appropriate based on preset reference values; and an output section 17 configured to output, on a per-unit task basis, information as to whether or not the process is being appropriately performed, based on results of the determination. The monitoring device 1 and the program make it possible to determine an abnormality in a product at the stage of manufacturing thereof before the inspection process 104 following the assembly process in the production line 100 is performed to determine whether or not the product is good or defective. This enables earlier detection of the occurrence of the abnormality. Since the monitoring is performed on a per-unit task basis, the unit task in which the abnormality has occurred can be more easily determined than in the case of monitoring on a per-process basis. It is therefore possible to identify a cause of a problem in the production line 100 earlier. In particular, in the case of the present embodiment, the operational condition acquisition section 11 acquires the operational conditions of the device for each of joining sites. It is therefore possible to identify a joining site having defective joining earlier.

(2) The monitoring device 1 further includes a preceding process content acquisition section 12 configured to acquire, as a preceding process content, information of processing performed in a process preceding the process for which the operational conditions have been acquired, and an association section 13 configured to associate the acquired operational conditions with the acquired preceding process content. The output section 17 outputs the operational conditions and the preceding process content associated therewith. Thus, the operational conditions can be outputted in combination with the information of the processing performed in the preceding process. This assists with identification of a cause of an abnormality that has occurred.

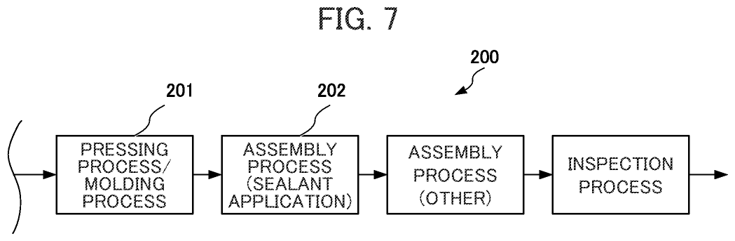

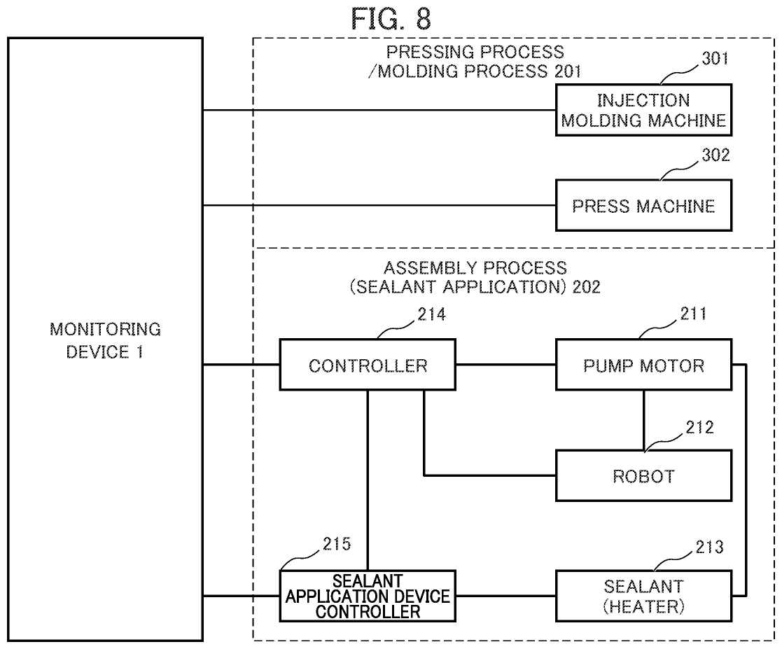

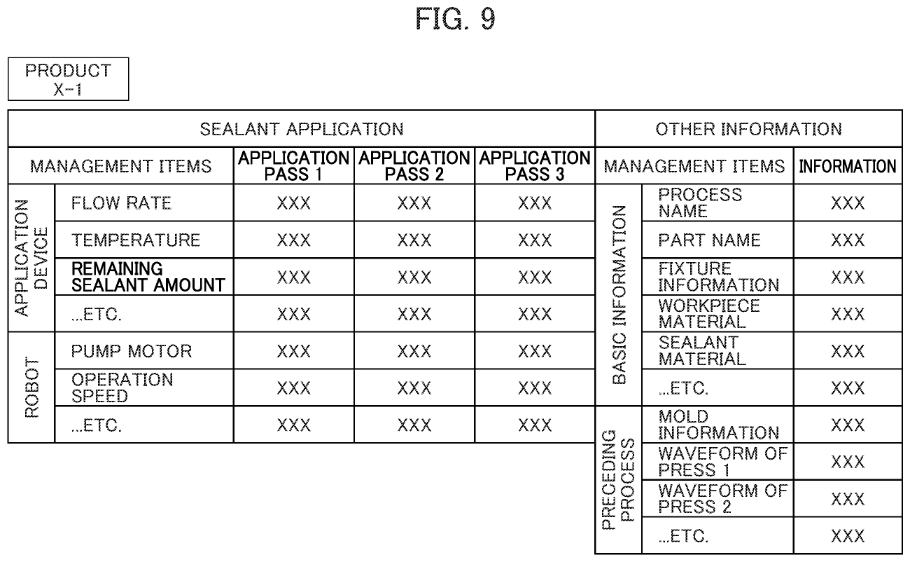

A monitoring device and a program according to a preferred embodiment of the present disclosure have been described above. However, the present disclosure is not limited to the embodiment described above and can be changed as appropriate. For example, regarding the embodiment described above, an example is described in which the monitoring device 1 monitors the assembly process (arc welding) 102. However, the present disclosure is not limited as such. The monitoring device 1 may monitor a plurality of processes in a production line 200. For example, the monitoring device 1 may monitor another process, which may be an assembly process (sealant application) 202 included in the production line 200 as illustrated. in FIG. 7. The monitoring device 1 is connected to a controller (robot controller) 214 and a sealant application device controller 215 as illustrated in FIG. 8. The controller 214 controls a pump (motor) 211, a robot 212, a sealant (heater) 213, and the sealant application device controller 215. The monitoring device 1 acquires operational conditions of each of the devices (the pump motor 211, the robot 212, the sealant (heater) 213, the controller 214, and the sealant application device controller 215) from the controller 214 and the sealant application device controller 215 on a per-unit task basis (for each of machining sites). The monitoring device 1 is also connected to an injection molding machine 301 and a press machine 302 involved in a pressing process/molding process 201 preceding the assembly process (sealant application) 202. As shown in FIG. 9, the monitoring device 1 uses, as unit tasks, three joining sites, which are application passes 1 to 3, and acquires operational conditions for each of the unit tasks.

Furthermore, the preceding process content acquisition section 12 in the embodiment described above may acquire information of processing performed in the preceding process directly from the press machine 121. Alternatively, the preceding process content acquisition section 12 may acquire the preceding process content from a server (not shown) or the like storing the preceding process content.

Regarding the embodiment described above, as an example of the monitoring on a per-joining site basis, the cases are mentioned where the monitoring is performed for each of line segment-like joining sites, which are the weld passes or the application passes. However, the present disclosure is not limited as such. For example, the monitoring may be performed for each of dot-like joining sites, which are welding points (spots), application points, or the like, or for each of line segment-like joining sites and dot-like joining sites.

Regarding the embodiment described above, arc welding and sealant application are mentioned as examples of tasks. However, the present disclosure is not limited as such. For example, the tasks may be joining such as mechanical joining or adhesive joining. Mechanical joining may be, for example, laser welding, resistance welding, friction stir joining, ultrasonic joining, rivet joining, or bolting. For another example, the tasks may be tapping or drilling, or machining such as roughing, finishing, or post-machining with the use of a machine or a laser. In the case of any of these types of machining, the operational condition acquisition on a per-unit task basis may be operational condition acquisition on a per-machining site basis. In this case, the present disclosure allows for earlier identification of a machining site having a machining defect.

### EXPLANATION OF REFERENCE NUMERALS

1: monitoring device
11: operational condition acquisition section
12: preceding process content acquisition section
13: association section
16: determination section
17: output section
100: production line

What is claimed is:

1. A monitoring device for monitoring a status of a process in a production line in separate unit tasks, the production line including a plurality of processes, the unit tasks forming the process, the monitoring device comprising:
an operational condition. acquisition section configured to acquire, on a per-unit task basis, operational conditions of a device being used in the tasks;
a determination section configured to determine whether or not the acquired operational conditions are appropriate based on preset reference values; and
an output section configured to output, on a per-unit task basis, information as to whether or not the process is being appropriately performed, based on results of the determination.

2. The monitoring device according to claim 1, further comprising:
a preceding process content acquisition section configured to acquire, as a preceding process content, information of processing performed in a process preceding the process for which the operational conditions have been acquired, and
an association section configured to associate the acquired operational conditions with the acquired preceding process content, wherein
the output section outputs the operational conditions and the preceding process content associated therewith.

3. The monitoring device according to claim 1, wherein the operational condition acquisition section acquires the operational conditions of the device being used in the tasks for each of machining sites.

4. A storage medium encoded with a program for causing a computer to function as a monitoring device for monitoring a status of a process in a production line in separate unit tasks, the production line including a plurality of processes, the unit tasks forming the process,
the program being configured to cause the computer to function as:
an operational condition. acquisition section configured to acquire, on a per-unit task basis, operational conditions of a device being used in the tasks;
a determination section configured to determine whether or not the acquired operational conditions are appropriate based on preset reference values; and
an output section configured to output, on a per-unit task basis, information as to whether or not the process is being appropriately performed, based on results of the determination.
